(19) United States
(12) Patent Application Publication
(10) Pub. No.: US 2016/0260419 A1
(43) Pub. Date: Sep. 8, 2016

(54) PIANO TUNING PIN APPARATUS

(71) Applicant: Korhan Karagulle, Istanbul (TR)

(72) Inventor: Korhan Karagulle, Istanbul (TR)

(21) Appl. No.: 14/636,640

(22) Filed: Mar. 3, 2015

(51) Int. Cl. G10C 3/10

(52) U.S. Cl. CPC G10C 3/10

(57) ABSTRACT

The present invention relates to a piano tuning pin apparatus comprising a primary tuning pin attached with a first end of a piano string. The apparatus further comprises a secondary tuning pin consisting of a conical body adapted to receive a second end of the string, wherein the conical body further comprises a plurality of spiral grooves allowing fine tuning via slow and smooth stretching of the string upon rotation of the secondary tuning pin, for adjusting the tension of the string to achieve an accurate pitch of sound.

### FIELD OF THE INVENTION

The present invention generally relates to a system for tuning of a piano and more specifically relates to a fine tuning pin used for accurate tuning to identify the correct pitch of sound.

### BACKGROUND OF THE INVENTION

Tuning of stringed instruments such as piano is often needed to achieve a desired pitch of sound. Musical instruments like piano are subject to go out of tune due to different factors including temperature, humidity, frequent movement of the instrument from one place to another, repeated and hard usage of the instrument. Therefore, it is inevitable to maintain stringed instruments in tune, especially piano needs to be tuned every two months or twice a week depending upon the usage conditions.

Typically a piano string is coiled around a tuning pin in such a way that the tension of the string can be adjusted by rotating the pin about its central axis with a suitable tool such as a tuning wrench. Tuning a piano accurately needs expertise of an experienced tuner. Generally, it's a tedious and difficult work to tune a piano accurately and fixing the correct pitch with the use of current tuning pins due to very short twisting range of the existing tuning pins that are adjustable using the tuning wrench.

Conventional tuning pins involves a threaded metal pin driven into a tuning pin block usually made of wood. The grip of the pin in the wooden block depends on the thread present around the tuning pin. Repeated usage of tuning pin or climatic changes may result in sagging or splitting of tuning pin block. In addition, tuning the piano very often can cause attrition around the hole of the tuning pins in course of time.

Numerous patents exists in the prior art, disclosing different design and operation mechanism of piano tuning pins. For example, U.S. Pat. No. 4,476,770 discloses a tuning pin for direct mounting on the string plates of mechano-acoustic pianos. U.S. Pat. No. 5,869,780 shows a tuning pin apparatus having an impediment function against rewinding. U.S. Pat. No. 5,471,902 shows a tuning system for piano comprising a tuning pin with an aperture for securing a tuning wire, retained in a metal assembly. U.S. Pat. No. 6,888,056 discloses an apparatus for lifting and setting a piano string coil is provided for improving tuning stability.

However, tuning pins existing in the art suffers from limitations including difficulty in accurate tuning of the pin due to its limited twisted range, when tuned with a tuning wrench. In addition, attrition around the hole of the tuning pins due to frequent or rough usage may result in loss of firm hold inside the tuning block in due course of time.

Accordingly there exists a need for an improved tuning pin for accurate fine tuning of piano to identify the correct pitch of sound.

### SUMMARY OF THE INVENTION

The present invention relates to a piano tuning pin apparatus comprising: a primary tuning pin attached with a first end of a piano string and a secondary tuning pin comprises a conical body adapted to receive a second end of the string, wherein the conical body comprises spiral groove allowing smooth stretching of the string upon rotation of the secondary tuning pin, allowing fine tuning of the string.

### BRIEF DESCRIPTION OF DRAWINGS

FIG. 1 is a perspective view of the piano tuning pin apparatus comprising a primary tuning pin and a secondary tuning pin, according to an embodiment of the present invention.

FIG. 2 is a perspective view of a secondary tuning pin in a tuning pin block, according to an embodiment of the present invention.

FIG. 3 illustrates a tuning pin array, according to an embodiment of the present invention.

FIG. 4A is a perspective view of the piano tuning pin apparatus comprising a secondary tuning pin smaller than a primary tuning pin. FIG. 4B is a perspective view of a secondary tuning pin in a tuning pin block, according to an embodiment of the present invention.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

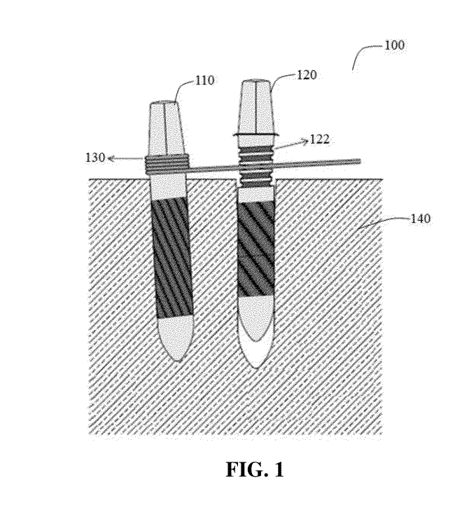

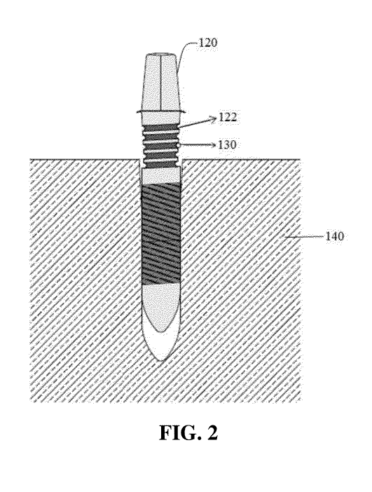

Referring to FIG. 1, which shows a perspective view of a piano tuning pin apparatus according to an embodiment of the present invention, the apparatus 100 comprising a primary tuning pin 110 attached with a first end of a tuning string 130, wherein the string 130 is coiled around a neck portion of the primary tuning pin 110. The apparatus 100 further comprises a secondary tuning pin 120 with a conical body adapted to receive a second end of the string 130, wherein the conical body comprises a spiral groove 122 to hold the string 130 and allows smooth stretching of the string upon rotation of the secondary tuning pin 120, thus allowing fine tuning of the string 130. The tuning pins 110, 120 are fitted into respective holes present in a tuning pin block 140.

The tuning pins of the apparatus allows adjustment of string tension by stretching the string in order to achieve a desired pitch of sound. In an embodiment, the secondary tuning pin 120 alone allows fine tuning of the string without the need to tune the primary tuning pin 110. In addition, the secondary tuning pin 120 provides extended twist range while tuning the string using a tuning wrench or similar tuning means.

FIG. 2 shows a perspective view of a secondary tuning pin in a tuning pin block, according to an embodiment of the present invention. The secondary tuning pin 120 is fitted into a respective hole in a tuning block 140, wherein the tuning block is typically made of wood. The secondary tuning pin 120 comprises spiral grooves or threads 122 allowing winding of the string 130. The conical shape of the pin 120 and spiral grooves 122 allow smooth and slow stretching of the string allowing fine tuning of the instrument.

Normally, as mentioned above, a tuning wrench has a very short and limited twisting range on the current tuning pins which causes the difficulty to find the correct pitch of the sound. The principle of fine tuning with secondary tuning pin is to allow smooth stretching of the string without using the primary tuning pin. The process of fine tuning is to facilitate to find the correct pitch of the sound by giving an extended twisting range to the tuning wrench. When the secondary tuning pin was twisted with the wrench in the extended range, it would smoothly and slowly affect the tension of the string by stretching it until finding an accurate pitch of sound.

One of the major limitation with conventional tuning pins is loosening of the tuning pin fitted in the tuning block in due course of time, whereas the presence of secondary tuning pin overcomes the above limitation by taking the pressure off the primary tuning pin during fine tuning. In addition, the secondary or supplementary tuning pin reduces tension of the string toward agraffe.

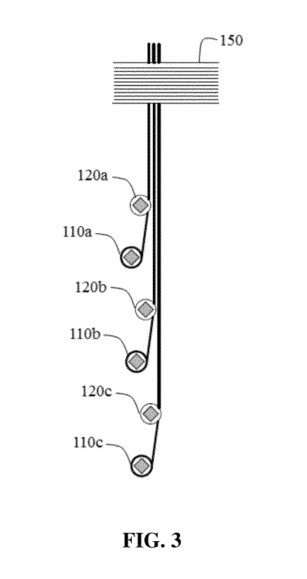

FIG. 3 shows a tuning pin array according to an embodiment of the present invention. The tuning pin array of the instrument comprises a series of secondary tuning pins 120a, 120b and 120c placed before primary tuning pins 110a, 110b and 110c respectively. The piano tuning string extends from the pressure bar 150 till the primary tuning pin by passing around the spiral grove of the secondary tuning pin.

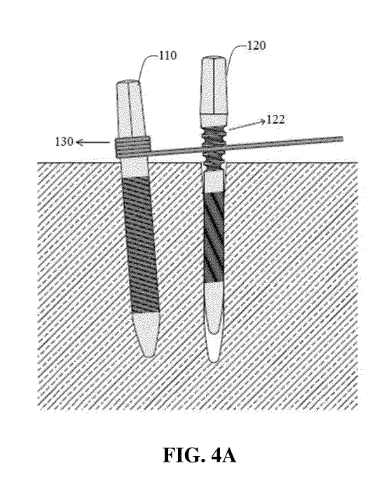

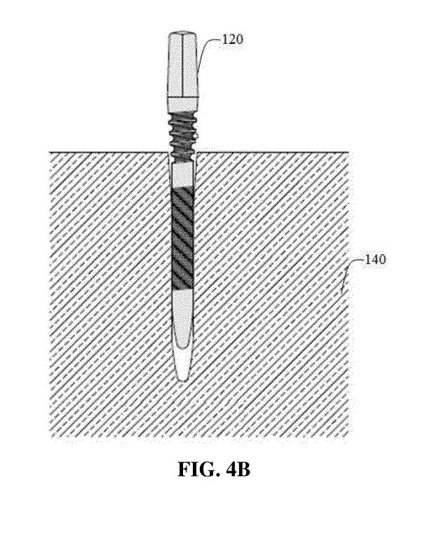

In an embodiment, the size of the secondary tuning pin 120 is smaller than the primary tuning pin 110 as shown in FIG. 4A. The secondary tuning pin 120 comprises conical shaped threads 122 for holding the string 130. The distal part of the secondary tuning pin 120 is shaped in order to fit inside respective radial bore of the tuning pin block 140 as shown in FIG. 4B. The secondary tuning pin can be disposed adjacent to the primary tuning pin. The tuning end or head part of the tuning pins are shaped to accommodate a tuning lever or a tuning wrench or a similar device thereby allowing tightening or loosening the tension of string. For example, the tuning end of the pins may comprise four flat surface on the sides to accommodate a tuning wrench.

In another embodiment, the primary tuning pin may comprise a hole or an aperture to receive and secure the first end of the piano tuning string or tuning wire prior to winding of the tuning wire around the neck region of the tuning pin.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A piano tuning pin apparatus comprising:
a primary tuning pin attached with a first end of a piano string; and
a secondary tuning pin comprises a conical body adapted to receive a second end of the string, wherein the conical body comprises spiral groove allowing smooth stretching of the string upon rotation of the secondary tuning pin.

2. The apparatus of claim 1, wherein the secondary tuning pin is disposed adjacent to the primary tuning pin.

3. The apparatus of claim 2, wherein the secondary tuning pin is disposed in front of the primary tuning pin.

4. The apparatus of claim 1, wherein the secondary tuning pin allows fine tuning of the piano string independent of the primary tuning pin.

5. The apparatus of claim 1, wherein the secondary tuning pin provides extended twisting range to a tuning wrench.

6. The apparatus of claim 1, wherein the secondary tuning pin is smaller in size than the primary tuning pin.

7. The apparatus of claim 1, wherein the primary and secondary tuning pin is fixed in a tuning pin block.
